(19) United States
(12) Patent Application Publication
(10) Pub. No.: US 2018/0063055 A1
(43) Pub. Date: Mar. 1, 2018

(54) REPARTITIONING A TOPIC IN A PUBLISH-SUBSCRIBE MESSAGE SYSTEM

(71) Applicant: LinkedIn Corporation, Mountain View, CA (US)

(72) Inventors: Kartik Paramasivam, Sunnyvale, CA (US); Jiangjie Qin, Sunnyvale, CA (US)

(73) Assignee: LinkedIn Corporation, Mountain View, CA (US)

(21) Appl. No.: 15/248,849

(22) Filed: Aug. 26, 2016

(51) Int. Cl. H04L 12/58

(52) U.S. Cl. CPC H04L 51/12; H04L 51/16

(57) ABSTRACT

A system, method, and apparatus are provided for repartitioning a topic of a publish-subscribe message system. The topic is originally configured with N partitions (N>1) hosted by multiple brokers for storing messages to be consumed by multiple consumers. The repartitioning process causes one or more collections of partitions to be created in addition to the original collection of N partitions. Afterward, when a new message is received for the topic and has an associated partition key, the key is processed (e.g., hashed) once to identify a target collection of partitions and is then reprocessed to identify a destination partition within the target collection. Consumers may be automatically subscribed to new partitions. For example, a consumer subscribed to the i^{th} partition of the original N partitions may be subscribed to the i^{th} partition of each additional collection of partitions.

### BACKGROUND

This disclosure relates to the field of computers. More particularly, a system, method, and apparatus are provided for repartitioning a topic within a publish-subscribe messaging system.

An illustrative publish-subscribe message system, such as Apache Kafka, may feature multiple publishers generating messages for retention by one or more brokers and retrieval by any number of consumers. In such a system, messages may be categorized or divided into logical structures called topics. Each topic is divided into a number of partitions, each of which acts as a commit log and provides ordered and immutable delivery of messages delivered to that partition. A topic's partitions may be stored (and may be replicated) on any number of brokers, and subsequently retrieved by consumers, each of which typically subscribes to a single partition. An application or consumer group may, however, control multiple consumers that each subscribe to different partitions.

In some environments, a need may develop to increase the number of partitions in a given message topic. For example, the rate of production of messages for that topic may increase to the point where each original partition could grow beyond the storage capacity of a broker. Increasing the number of topic partitions would allow each resulting partition to store fewer messages.

However, the consumers within an application (or a consumer group) are typically tied to specific partitions, and adding new partitions may cause some messages for the topic to be missed because no consumer will be subscribed to the new partition(s). This is particularly an issue if the consumers do not share state data among themselves, which prevents them from learning of the status of a particular partition from another consumer.

### DESCRIPTION OF THE FIGURES

FIG. 1 is a block diagram depicting a publish-subscribe message system in which a message topic may be repartitioned, in accordance with some embodiments.

FIG. 2 illustrates multiple consumer instances of a consumer group subscribed to partitions of a message topic, in accordance with some embodiments.

FIG. 3 illustrates multiple consumer instances of a consumer group subscribed to partitions of a message topic after the topic is repartitioned, in accordance with some embodiments.

FIG. 4 is a flow chart illustrating a method of repartitioning a topic of a publish-subscribe message system, in accordance with some embodiments.

FIG. 5 depicts an apparatus for repartitioning a topic of a publish-subscribe message system, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for repartitioning a topic of a publish-subscribe message system. In the message system, message producers generate messages divided into any number of topics and deliver them to a set of message brokers. The message brokers retain the messages for some period of time. Message consumers subscribe to the topics in order to receive the corresponding messages.

In these embodiments, each topic is initially divided into some number of partitions, with each partition being stored on a separate message broker and possibly being replicated or otherwise copied for fault-tolerance and/or load-balancing purposes. As a given topic grows or becomes very popular, the number of messages delivered to a particular partition of the topic may become too great to store on a single broker. At this point the topic may need to be repartitioned so as to comprise a greater number of partitions, each of which may be smaller in size and require less storage space and/or other resources.

For example, a topic that initially consisted of N partitions (N>1) may be repartitioned to comprise some multiple X of N partitions (X>1), for a total of M=X*N partitions. The repartitioned topic can be envisioned as comprising X buckets or collections of partitions, with each bucket or collection including N partitions. The original N partitions comprise one of the collections or buckets.

Although the resulting number of partitions is an integer multiple of the original number of partitions in these embodiments, in other embodiments this is not necessary. Instead, the total number of partitions (M) in the repartitioned topic may be divided across multiple buckets or collections such that one bucket/collection contains more (or fewer) partitions than another bucket/collection.

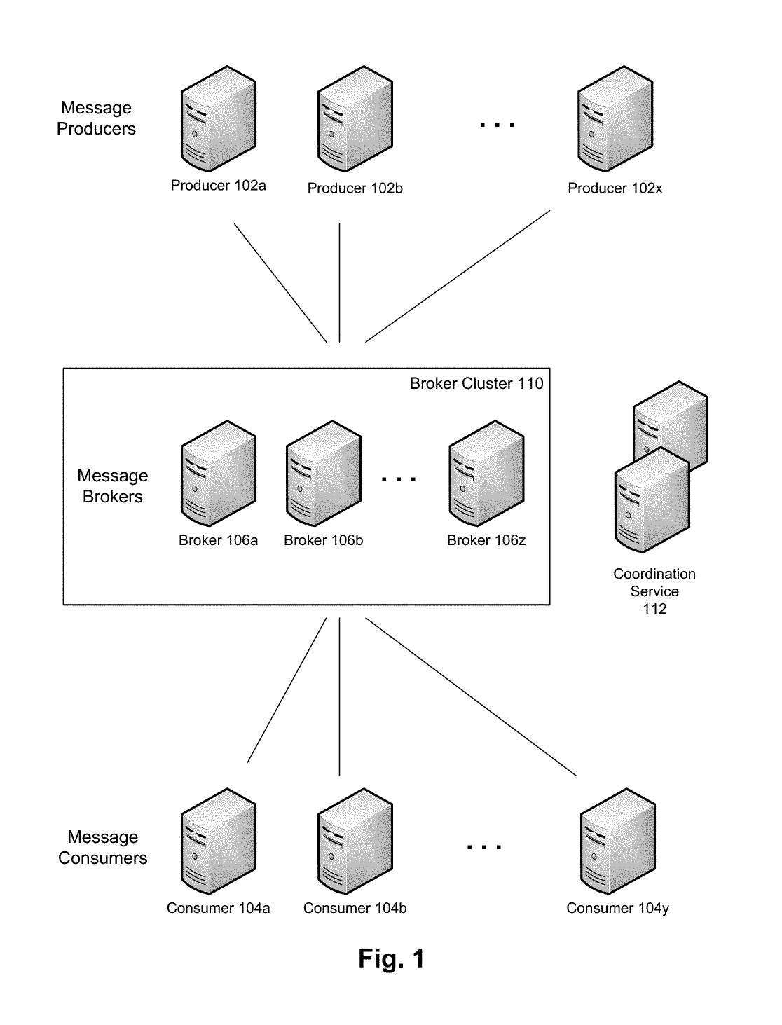

FIG. 1 is a block diagram depicting a publish-subscribe message system in which a message topic may be repartitioned, according to some embodiments.

In these embodiments, message producers 102a-102x produce messages corresponding to one or more topics, and submit them to broker cluster 110 to make them available to message consumers 104a-104y. Broker cluster 110 includes message brokers 106a-106z that store the messages within the partition(s) allocated to the topic.

Coordination service 112, which comprises one or more computer servers, maintains and shares system metadata and information throughout the broker cluster. For example, the coordination service may expose a unique network-accessible path for each broker that maintains a heartbeat, wherein the path signifies that the broker is operational, so that the availability of each broker can be easily determined.

A typical message topic within the publish-subscribe message system of FIG. 1 is divided into multiple partitions, each of which is stored in its entirety on a broker 106; typically, a broker stores multiple partitions corresponding to one or more topics. Although a given partition of a given message topic may be replicated or otherwise duplicated, usually only one copy, version, or replica of that partition will be stored on a given broker.

A message generated or otherwise obtained by a producer, for a specified topic, may be accompanied by or may be associated with a partition key that can be used to identify a destination partition. For example, producers (and/or brokers) may execute a common hashing algorithm on the partition keys they receive, in order to identify corresponding destination partitions. Illustratively, the hashing algorithm will always identify the same destination partition for a given partition key (e.g., as long as the number of brokers remains constant).

A consumer 104 may be an individual consumer instance or process, or may be a consumer group consisting of multiple consumer instances (or processes). Multiple consumer instances (of the same group or different groups) may execute on a single computing device. Typically, each message in a given partition of a given topic is consumed by only one consumer instance in a particular consumer group. A consumer group may be alternatively termed a container.

In an illustrative implementation of the publish-subscribe system of FIG. 1, an application, service, or other entity that is to receive messages belonging to a particular topic will encompass multiple consumer instances, each of which subscribes to one or more partitions of that topic. Therefore, every message published within that topic will get to the application, regardless of the partition in which it is placed. The application's consumers may be considered part of one consumer group that corresponds to or is associated with the application.

In some embodiments, consumers 104 do not share state data or statuses among themselves, even among different instances within one consumer group. Therefore, there is no mechanism or means for multiple consumers to cooperate in the consumption of messages in a particular partition or topic (e.g., to ensure each partition of a message topic is serviced). As one result described further below, when a new partition is created for a message topic, a lack of coordination among consumers of that topic may cause messages in that partition to be missed or lost if a repartitioning scheme provided herein is not applied.

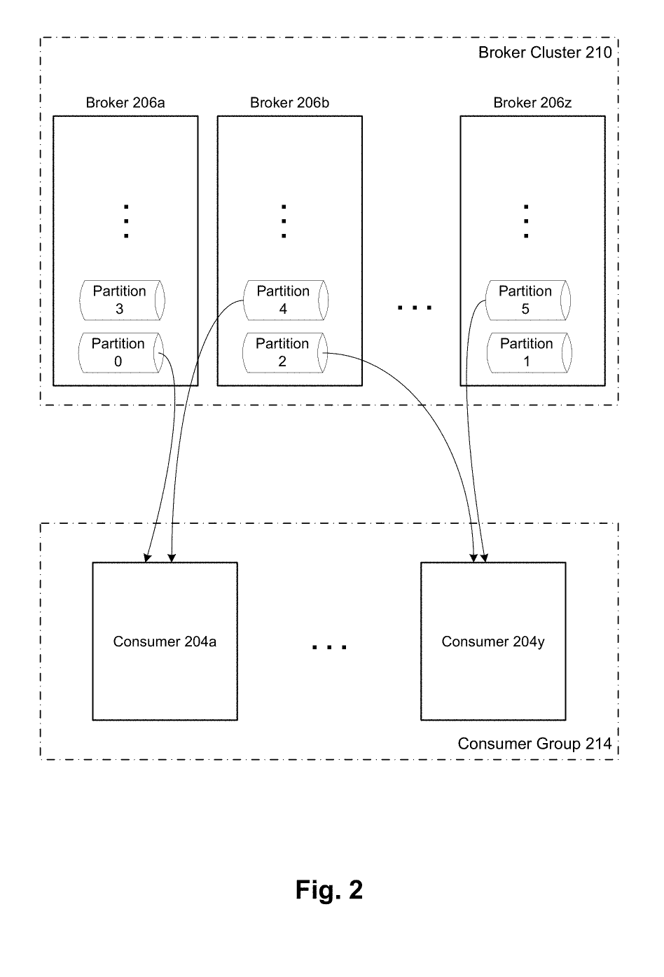

FIG. 2 illustrates multiple consumer instances within a consumer group subscribed to partitions of a message topic, according to some embodiments.

In these embodiments, partitions of the topic reside on brokers 206a-206z of broker cluster 210, for consumption by consumers 204a-204y of consumer group 214. As shown, consumer instance 204a subscribes to partitions 0 and 4 (and possibly others), consumer instance 204y subscribes to partitions 2 and 5 (and possibly others), and other consumer instances in the consumer group subscribe to the other partitions.

In some implementations, but not all, the number of partitions within the topic is a power of two (e.g., 8, 16, 32), and the partitions may be distributed evenly or unevenly among brokers 206a-206z. Similarly, there may be any number of consumer instances within consumer group 214 (e.g., 2 or more), and all consumers may subscribe to the same number of topic partitions or to different numbers of partitions.

When a message topic is repartitioned using a technique described herein, the number of topics may be increased by an integer factor greater than or equal to two. Thus, if the number of partitions employed before the technique is applied is N (N≧1), the resulting number of partitions is equal to X*N (X>1). The original N partitions may be considered one collection of partitions, in which case an additional X−1 collections of partitions are added to the message topic.

In some implementations, each consumer that was subscribed to at least one partition of the message topic prior to the repartitioning is subscribed to the same number of partitions in each extra collection of partitions, and the additional partitions to which it is subscribed may be in the same ordinal position. For example, consumer 204a was subscribed to partitions 0 and 4 of the original collection of, say, 8 partitions. After repartitioning, consumer 204a is still subscribed to partitions 0 and 4, but may now also be subscribed to new partitions 8 and 12. Similarly, after the repartitioning, consumer 204y is subscribed to old partitions 2 and 5, and new partitions 10 and 13.

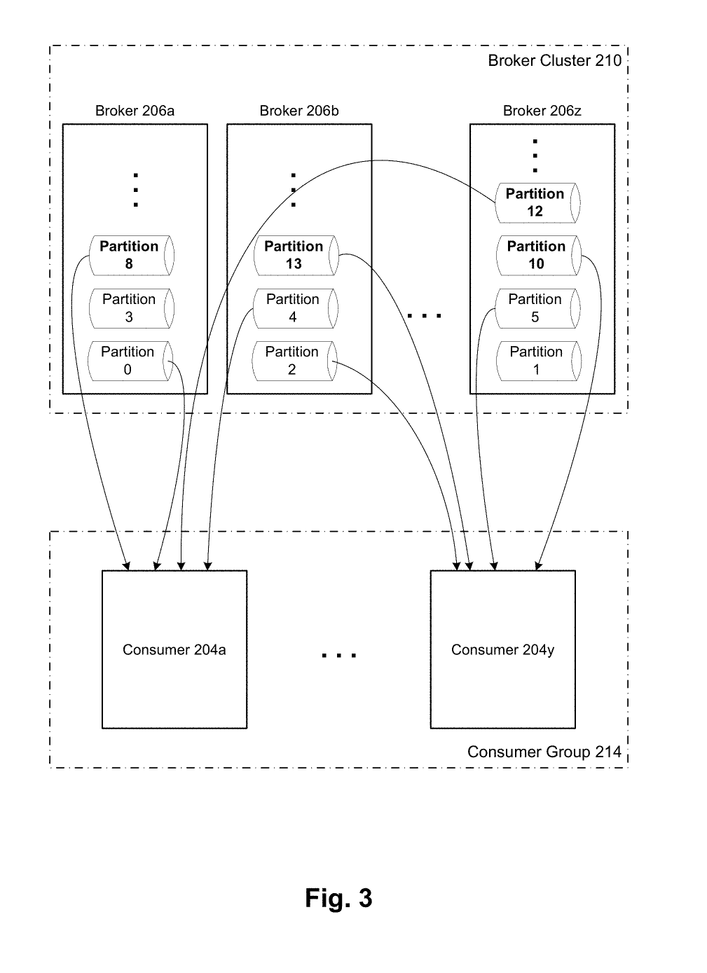

This is depicted in FIG. 3, which illustrates subscription to a repartitioned message topic by multiple consumer instances of a consumer group, according to some embodiments. Note that each partition of a new collection of partitions may or may not be stored on the same broker that stores the corresponding partition of the original collection. Thus, partition 8 is stored on broker 206a with corresponding partition 0, but partition 13 is stored on broker 206b even though corresponding partition 5 is stored on broker 206z.

Although a given consumer in the publish-subscribe message system illustrated in FIGS. 2-3 was subscribed to multiple partitions of the illustrated topic before repartitioning occurred, in other embodiments or environments, each consumer within a consumer group may subscribe to only a single partition of the topic prior to repartitioning. Afterward, it will subscribe to two if the number of partitions is doubled, three if the number of partitions is tripled, etc.

Previously known techniques for increasing the number of partitions within a topic generally caused a message to be delivered to a different partition after the number of partitions increased, as opposed to before the increase, even when accompanied by the same partition key. For example, a different hashing algorithm may be applied and/or the hashing results may differ because the algorithm is based on the increased number of partitions. As a result, and especially in an environment in which message consumers do not share state data, messages may be lost because they may be placed in new partitions that are not serviced or that are not serviced until after one or more messages in the new partitions have already been lost. In contrast, in the techniques presented herein for repartitioning a message topic, a partition key will cause an associated message to be deposited in either the same partition (of the original N partitions) after the repartitioning as before the repartitioning, or in a corresponding partition in one of the new collections of partitions.

Prior to repartitioning a message topic as described herein, upon receipt of a new message for the topic, the process of selecting one of the topic's N partitions (N≧1) to receive the message involved applying a single (hashing) operation to the message's associated partition key. After the message topic is repartitioned, the process of selecting a destination partition involves multiple operations with the partition key. For example, a first operation (e.g., a hashing operation) may be applied to determine which of the multiple collections of N partitions should receive the message. A second operation (e.g., another or the same hashing operation) is then applied to identify one of the N partitions in the selected collection as the target destination.

Illustratively, the ordinal position of the destination partition within the selected partition collection will match the ordinal position of the partition that would have been selected if the repartitioning never took place. For example, if a given partition key mapped to partition 2 in the publish-subscribe message system of FIG. 2 prior to repartitioning of the illustrated message topic having 8 partitions, after the repartitioning it would map to either partition 2 (of the first collection of 8 partitions) or partition 10 (of the second collection of 8 partitions) in the repartitioned message topic of FIG. 3. If the number of partitions had tripled instead of doubled, then a partition 18 of a third collection of 8 partitions would also be a candidate, and if the number of partitions had quadrupled, then a partition 26 of a fourth collection of partitions would become a candidate, and so on.

These schemes may be applied whenever the new total number of partitions is no greater than the square of the original N partitions (N>1). If an even greater increase in the number of partitions is required, however, such as from 4 partitions to some number of partitions greater than 16, a scheme provided herein may be extended to add yet another operation. For example, a first operation (e.g., hashing operation) could be applied to a message's partition key to identify, in this example, which set of N² (16) partitions should receive the message, then another operation (or the same operation) could be applied to select one of the 4 collections of N partitions in the selected set, and finally one more operation (or the same operation) could be applied to identify the destination partition within the selected collection within the selected set. Again, the partition will have the same ordinal position in the selected collection would have been selected among the original N (4) partitions prior to repartitioning.

As part of the partitioning process, in some implementations existing consumers are notified of the creation of new partitions and are automatically subscribed or directed to subscribe to the new partition(s) that match the ordinal positions of the partitions to which they are already subscribed. Using the environment of FIG. 3 to explain an example, special control or management messages may be injected into partitions 0 and 4 to inform consumer 204a that it is now also subscribed to partitions 8 and 10 (or that it should subscribe to the new partitions).

In some other implementations, consumer group 214 or an associated application or other entity is notified (e.g., by coordination service 112 of FIG. 1) of the repartitioning and the new partitions, and it modifies, replaces, or augments its consumers as warranted or required. For example, one or more members of the consumer group may poll a broker cluster (e.g., one or more members of a broker cluster—such as a broker acting as a controller), possibly for a specific topic, and learn that there is a new partition or set of partitions for that topic and/or some other topic.

Whether a consumer learns of a new partition via a control message, via polling, or via some other mechanism, it may also receive or obtain a corresponding timestamp. To help ensure that messages (e.g., all messages of a given topic) are consumed in order, the consumer may refrain from consuming messages from the new partition(s) until it has consumed previous messages (for the same topic) from other partitions. In some implementations, it will continually read messages from the preexisting partitions, check their timestamps, and begin servicing the new partition(s) after the timestamp (plus some buffer time, possibly).

In some embodiments, a publish-subscribe message system is employed in support of or as part of an online service or application that features an extensive user community. For example, the system may be employed within a social network or professional network offered by LinkedIn® Corporation. Messages within such a publish-subscribe message system may be produced, stored, and/or consumed by various computing devices as part of the process of capturing, recording, tracking, or otherwise noting user activities and/or system activities related to operation of the service (or application).

For example, the service may include one or more profile servers for maintaining profiles of members of the user community. An individual member's profile may include or reflect any number of attributes or characteristics of the member, including personal (e.g., gender, age or age range, interests, hobbies, member ID), professional (e.g., employment status, job title, job location, employer or associated organization, industry, functional area or role, skills, endorsements, professional awards, seniority), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify or characterize the member, to characterize a member connection that involves the member, to characterize content with which the member interacts, to identify content topics/items that may interest the member, to select content to serve to the member, to record a content event).

Organizations may also be members of the user community (i.e., in addition to individuals), and may have associated descriptions or profiles comprising attributes such as industry, size, location, goal or purpose, etc. An organization may be a company, a corporation, a partnership, a firm, a government agency or entity, a not-for-profit entity, a group or collection of associated members, or some other entity formed for virtually any purpose (e.g., professional, social, educational). Either or both organizations and individual members may “follow” and/or be followed by other members, may share and/or received shared information, may initiate and receive communications with other members, may post content and/or receive content posted by other members, may form connections with other members, etc.

Further, the service may include one or more tracking servers for monitoring and recording activity of users and/or system components. For example, whenever content is served by the service (e.g., to a client device operated by a user), the tracking server may be informed of the content that is served, to whom (e.g., which user), when it was served, and/or other information. Similarly, the tracking server may also record user actions regarding content, to include identities of the users and the content acted upon, the action that was taken, when the action was taken, how long the interaction lasted, follow-on activity (if any), whether a current set of signals received from a device match previously stored signals, etc.

While depicted as separate and individual hardware components (e.g., computer servers) in FIGS. 1-3, producers 102, consumers 104/204, brokers 106/206, and/or coordination service 112 may alternatively be implemented as separate software modules executing on one or more computer servers. Thus, although only a single instance of a particular component of a publish-subscribe message system may be illustrated in FIGS. 1-3, it should be understood that multiple instances of some or all components may be utilized.

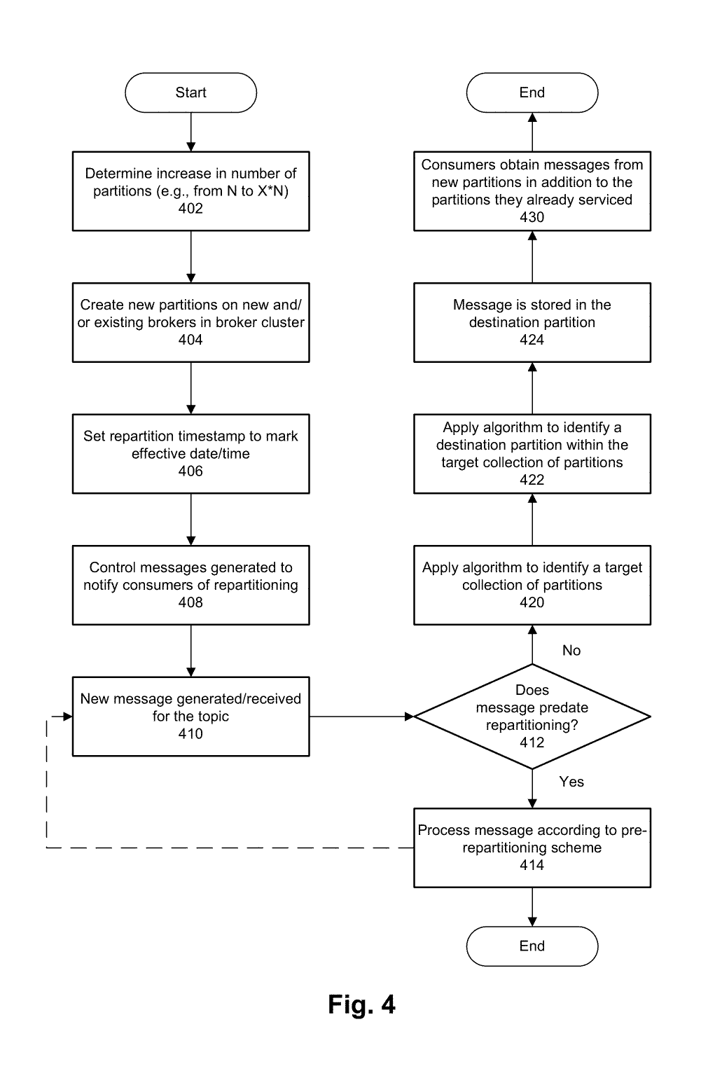

FIG. 4 is a flow chart illustrating a method of repartitioning a topic of a publish-subscribe message system, according to some embodiments. In other embodiments, one or more of the illustrated operations may be omitted, repeated, and/or performed in a different order. Accordingly, the specific arrangement of steps shown in FIG. 4 should not be construed as limiting the scope of the embodiments.

Prior to the illustrated repartitioning method, the message topic consists of N partitions (N>1) during operation of the message system. These may be considered to be the original or first collection or bucket of topic partitions. As explained above, the repartitioning process will add one or more new collections or buckets of partitions.

In operation 402, an operator or administrator of the message system determines a total number of new partitions for the repartitioned topic. The total number of partitions may be an integer multiple of N (e.g., X*N wherein X>1), in which case all resulting partition collections, including the original, will include the same number of partitions and the total number of partitions will be M=X*N. If the new total number of partitions is not an integer multiple of N, in some implementations they are arranged such that none of the resulting collections of partitions will differ from another collection by more than one partition.

In operation 404, the new partitions (X*N−N) are created on existing brokers and/or new brokers in the broker cluster that handles the topic's message traffic. In the illustrated method, the partitions in a typical collection may be identified with ordinal numerals from 0 to N−1. For purposes of discussion, a full set of corresponding partitions (i.e., the i^{th} partition of each collection, wherein 0≦i<N) may be termed a ‘slice.’ The members of a given slice may be hosted on different brokers or two or more of them may be hosted by the same broker. Any number of partition replicas may be created, now or at some later time, to provide redundancy and fault tolerance.

In operation 406, a timestamp identifying the effective date/time of the repartitioning is recorded in the brokers, a coordination service, and/or elsewhere. For example, message producers may be directly notified of the repartitioning (and the timestamp), may poll the coordination service, a broker, or some other entity, or may learn of the repartitioning in some other way. Until the date/time indicated by the repartition timestamp, messages in the topic are treated as usual by the message producers, brokers, and consumers.

In operation 408, special management, control, or administrative messages are placed in each of the original N partitions to inform the partitions' subscribers of the repartitioning. An illustrative message inserted into a given partition may identify the repartition timestamp and direct the subscribing consumer to subscribe to one or more specified new partitions, or may inform the consumer that it has been subscribed to them and should start retrieving messages (e.g., as of the repartition timestamp).

Thus, each consumer that subscribed to the 0^{th} partition (i.e., partition 0) in the original N partitions will be informed of the new 0^{th} partitions in the additional partition collection(s) (e.g., by path names, URIs, network addresses, etc.), each consumer that subscribed to the 1^{st} partition (i.e., partition 1) in the original N partitions will be informed of the new 1^{st} partition(s), and so on.

In embodiments in which brokers and/or consumers cannot create new subscription arrangements on their own, the messages may be acted upon by the consumer group, container, application, service, or other entity that receives messages obtained by a consumer.

In yet other embodiments, notification of the repartitioning may be sent directly to the entities that create new subscriptions and/or reconfigure existing subscriptions, or these entities may regularly poll a central location (e.g., a coordination service) to obtain metadata regarding the repartitioning and take action accordingly (e.g., reconfigure existing consumers to service the new partitions). For example, the application or consumer group that manages a set of consumers may reconfigure those consumers to subscribe to the new partitions).

Producers may learn of the repartitioning by polling the central location or by receiving notifications from the central location or some other entity. System metadata, which may be stored on brokers, a coordination service, and/or elsewhere is updated as part of the repartitioning.

In operation 410, a producer or producer client obtains (e.g., generates, receives) a new message for the message topic, with a corresponding partition key. The partition key may correspond to a subject of the message, a preferred communication channel, or other mechanism for discriminating among the topic's partitions, and may be used as described below to identify the partition (and broker) to receive the message.

In operation 412, the producer compares the message timestamp to the repartition timestamp. If the message predates the partition timestamp, the method continues at operation 414; otherwise, the method advances to operation 420.

In operation 414, the message is processed normally. In particular, the producer applies the applicable hashing algorithm (or other process) to the applicable partition key (if one exists), uses the result to identify the destination partition (among the original N partitions) and broker with which to place the message, and dispatches the message to the broker for storage in the specified partition. After operation 414, the method ends or returns to an earlier operation. For example, the method may return to operation 410 when another new message is received.

In operation 420, the producer applies the applicable hashing (or other) algorithm to the message's partition key a first time to identify one of the multiple collections of partitions. For example, the hashing algorithm may hash the partition key over the number of partition collections (e.g., X) and yield an integer value corresponding to one of the collections. This may be termed the target collection.

In operation 422, the producer applies the applicable hashing (or other algorithm) to the partition key a second time to identify, within the target collection, a destination partition to receive the message. For example, the hashing algorithm may hash the partition key over the number of partitions in the collection (e.g., N) and yield an integer value corresponding to one partition. Although the same hashing or other algorithm may be applied in both operations 420, 422 in these embodiments, in other embodiments different algorithms or processes may be used.

In operation 424 the message is delivered to and stored in the destination partition, and becomes available to the topic's consumers. To ensure the producers dispatch their messages correctly, they are provided with or otherwise have access to a mapping between partitions and brokers, so that after they determine the partition to receive a message they are able to identify the broker that hosts that partition.

In operation 430, a consumer that previously retrieved messages only from one or more given partitions of the topic's original N partitions now retrieves messages from all partitions in the same slice. After operation 430, the method ends or returns to another operation. For example, the method may return to operation 410 when another new message is received.

Some operations of the method illustrated in FIG. 4 may be performed by a producer (or producer client), a coordination service, a broker, a master broker or controller, a router or other similar entity that manages or controls access to the brokers, and/or some other entity. Other operations related to message consumption are performed by consumer entities.

In embodiments of repartitioning a message topic described above, an original collection of the topic's N partitions is augmented with one or more additional collections of partitions to yield a new total of M partitions (M>N). After the repartitioning, the original partitions remain in use along with the new partitions.

In some alternative embodiments, a repartitioning scheme creates M new partitions that temporarily coexist with the original N partitions, but the original N partitions eventually are closed and deleted. In these embodiments, before the effective date/time of the repartitioning (e.g., indicated by the repartition timestamp discussed above), all messages for the topic are placed in the original N partitions. After the repartitioning takes effect, new messages are placed in the new M partitions, and an attempt to place a message in one of the original partitions may result in an exception. The messages in the original partitions will remain available to consumers for the normal period of message retention.

The new M partitions may be logically grouped into multiple collections (e.g., of N partitions each if M is an integer multiple of N), and a message's partition key may still be processed twice to first identify a target collection of partitions and then to identify a destination partition in the target collection. Alternatively, the same method of selecting a destination partition may be applied as before the repartitioning, such that the partition key is processed only once (e.g., by hashing it over the number of partitions (M)) to identify the destination partition.

In these alternative embodiments, consumers may be subscribed to the new partitions (or informed of the new partitions) as the original partitions to which they were subscribed are emptied of messages. For example, when the original N partitions are closed to new messages, one or more final control or management messages may be injected into them to cause the consumers to subscribe to (or to be subscribed to) one or more of the new M partitions. As a result, the consumers consume the messages of the original partitions before beginning to consume messages placed in the new partitions.

In some embodiments, a consumer learns of a repartitioning after it occurs. For example, if a particular consumer wants to return to an earlier time period in a stream of messages for a given topic, that topic may have been repartitioned in the meantime. In this case, it determines when the repartitioning occurred (e.g., based on one or more control messages in the preexisting partitions(s)) and will read messages from the preexisting partitions, up to that time period, and then will start obtaining messages from the new partition(s) too.

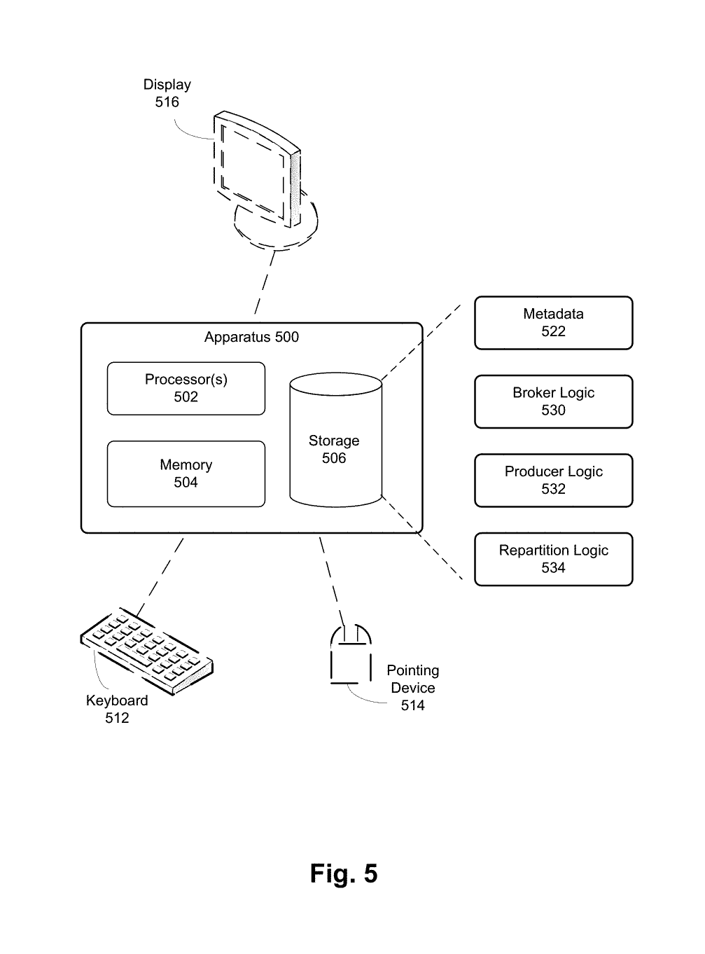

FIG. 5 depicts an apparatus for repartitioning a topic of a publish-subscribe message system, according to some embodiments.

Apparatus 500 of FIG. 5 includes processor(s) 502, memory 504, and storage 506, which may comprise one or more optical, solid-state, and/or magnetic storage components. Storage 506 may be local to or remote from the apparatus. Apparatus 500 can be coupled (permanently or temporarily) to keyboard 512, pointing device 514, and/or display 516.

Apparatus 500 includes functionality to execute various components of the present embodiments. In particular, apparatus 500 may include an operating system (not shown) that coordinates the use of hardware and software resources on the apparatus, as well as one or more applications or other logic constructs that perform specialized tasks. To perform these tasks, applications may obtain the use of hardware resources of apparatus 500 from the operating system, as well as interact with external entities (e.g., users, operators, other computing devices, other apparatuses, message consumers, message producers, a coordination service) through a hardware and/or software framework provided by the operating system.

Storage 506 stores metadata 522, which may include information regarding configuration and/or operation of the publish-subscribe message system. Such metadata may illustratively include any or all of (but is not limited to) the following: identities of producers, brokers, consumers, and/or other entities that host or support the system; addresses, paths, names, and/or other means for communicating with the entities; a mapping of consumers to the topic partitions to which they have subscribed (and/or a mapping of partitions to subscribed consumers); a mapping of topic partitions to the brokers on which they reside (and/or a mapping of brokers to the partitions they host); a repartition timestamp; etc.

Storage 506 also stores logic and/or logic modules that may be loaded into memory 504 for execution by processor(s) 502, such as broker logic 530, producer logic 532, and repartition logic 534. Any or all of these may alternatively be termed or implemented as a module, mechanism, or other type of system component. In other embodiments, any or all of these logic modules may be aggregated or divided to combine or separate their functionality as desired or as appropriate.

Broker logic 530 comprises processor-executable instructions that enable apparatus 500 to act as a broker within the publish-subscribe message system. As a broker, the apparatus receives and stores new messages for one or more message topics (or forwards them for storage, to a different apparatus/broker for example). The broker also interacts with message consumers to facilitate their consumption of messages, maintain consumer statuses (e.g., their offsets within the partitions to which they subscribe), etc.

Producer logic 532 comprises processor-executable instructions that enable apparatus 500 to act as a producer within a publish-subscribe message system. As a producer, the apparatus obtains (e.g., creates, assembles, receives) a new message for a particular topic, and also obtains (e.g., selects, identifies, receives) a corresponding partition key. The producer uses the key to identify the partition in which the message is to be stored, and forwards the message toward the broker that hosts that partition, for storage.

Repartition logic 534 comprises processor-executable instructions for repartitioning a message topic to increase its number of partitions, using a scheme described above. In particular, the repartition logic creates new partitions, updates metadata 522, notifies other entities of the repartitioning (e.g., consumers, producers), automatically subscribes consumers to new partitions or causes them to be subscribed, etc.

In some embodiments, broker logic 530, producer logic 532, and/or repartition logic 534 execute on different apparatuses and/or cooperate with other computing devices or entities to repartition a message topic and to support operation of the publish-subscribe message system. Also, in some embodiments, storage 506 also stores consumer logic, which comprises processor-executable instructions for operating as a message consumer (e.g., to subscribe to one or more partitions, to retrieve and process messages in those partitions, etc.).

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method comprising:
operating a publish-subscribe message system that includes a message topic having N original partitions (N>1);
during operation of the publish-subscribe message system, reconfiguring the topic to include multiple collections of partitions, wherein one of the multiple collections comprises the N original partitions;
obtaining a first message for the topic, wherein the first message has an associated partition key;
processing the partition key to identify a target collection of partitions of the topic; and
processing the partition key to identify a destination partition in the target collection of partitions; and
storing the first message in the destination partition of the target collection of partitions.

2. The method of claim 1, further comprising, at a first consumer of the publish-subscribe message system:
after said configuring, but before said reconfiguring, subscribing to a first partition of the N original partitions; and
after said reconfiguring, subscribing to the first partition of each of the multiple collections of partitions.

3. The method of claim 1, wherein said repartitioning comprises:
creating one or more additional collections of N partitions; and
for each consumer subscribed to an i^{th} partition in the original N partitions, subscribing the consumer to the i^{th} partition in each of the one or more additional collections of N partitions.

4. The method of claim 1, wherein said repartitioning comprises:
adding, to each partition of the N original partitions, a message directing a consumer of the partition to subscribe to one or more specified new partitions.

5. The method of claim 1, wherein said repartitioning comprises:
adding, to each partition of the N original partitions, a message informing a consumer of the partition that it has been subscribed to one or more specified new partitions.

6. The method of claim 1, wherein consumers of the topic share no state data.

7. The method of claim 1, wherein:
said obtaining, said processing, and said processing are performed by a publisher within the publish-subscribe message system.

8. An apparatus, comprising:
one or more processors; and
memory storing instructions that, when executed by the one or more processors, cause the apparatus to:
during operation of a publish-subscribe message system that includes a message topic having N original partitions (N>1), receive notification regarding reconfiguration of the topic to include multiple collections of partitions, wherein one of the multiple collections comprises the N original partitions;
obtain a first message for the topic, wherein the first message has an associated partition key;
process the partition key to identify a target collection of partitions of the topic;
process the partition key to identify a destination partition in the target collection of partitions; and
forward the first message for storage in the destination partition of the target collection of partitions.

9. The apparatus of claim 8, wherein the memory further stores instructions that, when executed by the one or more processors, cause the apparatus to:
after said configuring, but before said reconfiguring, cause a first consumer of the publish-subscribe message system to subscribe to a first partition of the N original partitions; and
after said reconfiguring, cause the first consumer to subscribe to the first partition of each of the multiple collections of partitions.

10. The apparatus of claim 8, wherein said repartitioning comprises:
creation of one or more additional collections of N partitions; and
for each consumer subscribed to an i^{th} partition in the original N partitions, subscription of the consumer to the i^{th} partition in each of the one or more additional collections of N partitions.

11. The apparatus of claim 8, wherein said repartitioning comprises:
an addition, to each partition of the N original partitions, of a message directing a consumer of the partition to subscribe to one or more specified new partitions.

12. The apparatus of claim 8, wherein said repartitioning comprises:
an addition, to each partition of the N original partitions, of a message informing a consumer of the partition that it has been subscribed to one or more specified new partitions.

13. The apparatus of claim 8, wherein consumers of the topic share no state data.

14. The apparatus of claim 8, wherein:
said obtaining, said processing, and said processing are performed by a publisher within the publish-subscribe message system.

15. A system, comprising:
one or more processors;
a repartition module comprising a non-transitory computer-readable medium storing instructions that, when executed, cause the system to:
during operation of a publish-subscribe message system that includes a message topic having N original partitions (N>1), reconfigure the topic to include multiple collections of partitions, wherein one of the multiple collections comprises the N original partitions;
a producer module comprising a non-transitory computer-readable medium storing instructions that, when executed, cause the system to:
obtain a first message for the topic, wherein the first message has an associated partition key;
process the partition key to identify a target collection of partitions of the topic; and
process the partition key to identify a destination partition in the target collection of partitions; and
a broker module comprising a non-transitory computer-readable medium storing instructions that, when executed, cause the system to:
store the first message in the destination partition of the target collection of partitions.

16. The system of claim 15, further comprising:
a consumer module comprising a non-transitory computer-readable medium storing instructions that, when executed, cause the system to:
after said configuring, but before said reconfiguring, subscribe to a first partition of the N original partitions; and
after said reconfiguring, subscribe to the first partition of each of the multiple collections of partitions.

17. The system of claim 15, wherein said repartitioning comprises:
creating one or more additional collections of N partitions; and
for each consumer subscribed to an i^{th} partition in the original N partitions, subscribing the consumer to the i^{th} partition in each of the one or more additional collections of N partitions.

18. The system of claim 15, wherein said repartitioning comprises:
adding, to each partition of the N original partitions, a message directing a consumer of the partition to subscribe to one or more specified new partitions.

19. The system of claim 15, wherein said repartitioning comprises:
adding, to each partition of the N original partitions, a message informing a consumer of the partition that it has been subscribed to one or more specified new partitions.

20. The system of claim 15, wherein consumers of the topic share no state data.
